(19) United States
(12) Patent Application Publication
(10) Pub. No.: US 2022/0054225 A1
(43) Pub. Date: Feb. 24, 2022

(54) HAND OPERATED SURGICAL INSTRUMENT HAVING AN IMPROVED TOOL BIT CONNECTOR

(71) Applicant: Charles Buist, DMD, PA, Hilton Head Island, SC (US)

(72) Inventor: Charles Buist, SR., Irmo, SC (US)

(73) Assignee: Charles Buist, DMD, PA, Hilton Head Island, SC (US)

(21) Appl. No.: 17/518,641

(22) Filed: Nov. 4, 2021

Related U.S. Application Data
(63) Continuation-in-part of application No. 16/157,511, filed on Oct. 11, 2018, now Pat. No. 11,191,622.
Application No. 16/157,511 is a continuation-in-part of application No. 15/860,799, filed on Jan. 3, 2018, now Pat. No. 10,758,319.
Application No. 15/860,799 is a continuation-in-part of application No. 15/981,964, filed on May 17, 2018, now Pat. No. 10,631,895.
Application No. 15/981,964 is a continuation-in-part of application No. 29/659,801, filed on Aug. 13, 2018, now Pat. No. D896963.
Application No. 29/659,801 is a continuation-in-part of application No. 16/108,539, filed on Aug. 22, 2018, now Pat. No. 10,772,705.

(51) Int. Cl. A61C 1/00; A61C 1/08

(52) U.S. Cl. CPC A61C 1/003; A61C 1/08

(57) ABSTRACT

The present invention relates to a hand operated dental instrument that allows a user to manually operate tool bits that are ordinarily operated by a power operated tool or a unitary hand-held device. The invention includes a handle that carries a shaft; a bore-hole extending through at least a portion of the shaft for receiving a portion of a tool bit; and a spline receiving slot defined in the shaft. The invention also includes a tool bit having a flange that may carry a spline extending along a portion of a longitudinal axis of the tool bit so that when the tool bit is placed in the bore-hole, the spline receiving slot receives the spline so that when the shaft is rotated, the tool bit rotates.

### BACKGROUND OF THE INVENTION

### 1) Field of the Invention

The present invention relates to a hand operated dental instrument. More specifically, the present invention relates to an instrument that is adapted to receive various tool bits, including (without limitation) osteotomes, periotomes, drill bits, flat head bits, Phillips head bits, cutting bits, planing or shaping bits (such as chisel bits), and to manually torque or rotate the tool bit by torqueing or rotating the present invention.

### 2) Description of Related Art

Electric drills are well known in the field of dentistry. However, often times, the material to be removed or to otherwise be drilled is very small and/or requires precise placement of the drill. In such instances, the high angular velocity used by electric drill makes it very difficult to remove only small amounts and/or to operate the drill with the level of precision required by the dental procedure. It would be advantageous if the angular velocity of the drill bit could be better controlled and slowed.

Another drawback of an electric drill is that the user of the drill has very little feel for what material is being drilled or how much material is being removed. Therefore, it would also be advantageous if the user were provided more feel of what and how much material were being drilled.

In addition to electric drills, other one-piece hand held instruments are well known in the field of dentistry. One drawback of these instruments is that as the tip and/or bit of the tool wears out, the entire instrument must be replaced. Another drawback is the number of instruments that must be available to carry out a procedure.

Accordingly, it is an object of the present invention to provide a hand operated instrument that allows the tool bit to be rotated by hand and at the desired speed of the user.

Accordingly, it is an object of the present invention to provide a hand operated instrument that provides the user a greater level of control of what is being drilled and how much material is being removed by the drill.

Another object of the invention is to provide a hand operated instrument having a handle that can receive and operate a variety of tool bits to reduce the amount of equipment needed during a procedure, to reduce the manufacturing costs and materials, and to allow for disposal and/or replacement of the tool bits as opposed to the entire instrument.

Another object of the invention is to provide a tool having removable tool bits that is as durable, stable and easy to use as one-piece tools having non-removable tips and/or bits.

### SUMMARY OF THE INVENTION

The above objectives are accomplished according to the present invention by providing a hand operated instrument comprising: a handle; a shaft having an outer surface, a distal end and a proximal end wherein said proximal end is carried by said handle; a bore-hole defined in at least a portion of said shaft and extending from said distal end of said shaft towards said proximal end of said shaft, wherein said bore-hole is defined by at least one inner side wall; a spline receiving slot defined in said outer surface of said shaft and including a first side wall and a second side wall, both of which extend from said distal end of said shaft towards said handle, so that said spline receiving slot extends in a direction that is generally parallel to a longitudinal axis of said shaft; a tool bit having a body, a shank and a flange interconnecting said body and said shank, wherein said tool bit further includes a spline extending from a point that is adjacent to said flange and in a direction that is parallel to a longitudinal axis of said shank, said spline being adapted to be received by said spline receiving slot so that when said shank is inserted into said bore-hole and said handle is rotated, said spline engages at least one of said first side wall and said second side wall of said spline receiving slot so that rotation of said handle causes said tool bit to rotate.

In at least one embodiment, the hand operated instrument further comprises an elevated stop defined in said bore-hole for engaging a portion of said shank of said tool bit that is inserted into said bore-hole, wherein said elevated stop comprises: a first stop wall that extends from said at least one inner side wall of said bore-hole in a direction that is generally perpendicular to the longitudinal axis of said shaft; and, a second stop wall the extends from said first stop wall in a direction that is generally parallel to the longitudinal axis of said shaft.

In at least one embodiment, said tool bit further includes a first shank stop wall defined in said shank and extending in a direction that is generally perpendicular to the longitudinal axis of said shank and a second shank wall extending from said first shank stop wall in a direction that is generally parallel to the longitudinal axis of said shank, wherein when said shank is inserted into said bore-hole, said second shank wall engages said second stop wall so that rotation of said handle causes the shank to rotate.

In at least one embodiment, the hand operated instrument further comprises a securing ring receiving slot defined in said shaft, wherein at least a portion of said securing ring receiving slot extends through said at least one inner side wall of said bore-hole so that said securing ring receiving slot is in fluid communication with said bore-hole. In this embodiment, the instrument may also include a securing ring, at least a portion of which is received by said securing ring receiving slot so that at least a portion of said securing ring extends into said bore-hole so that said securing ring engages a portion of said shank that has been inserted into said bore-hole so that said securing ring presses said second shank wall towards at least one of said first stop wall and said second stop wall of said elevated stop.

In at least one embodiment, the spline receiving slot is in fluid communication with bore-hole such that at least one of said first side wall and said second side wall extends through both of said outer wall of said shaft and said inner wall of said bore-hole.

In at least one embodiment, the flange of said tool bit has a first end carried by said body of said tool bit and a second end that carries said shank, wherein said flange is tapered so that said second end has a diameter that is greater than a diameter of said first end and wherein said second end includes a generally flat surface. In another embodiment, the spline contacts at least a portion of said shank.

### BRIEF DESCRIPTION OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 shows a side elevation view with a cross-sectional view of a portion of an embodiment of the present invention;

FIG. 2 shows a perspective view of a portion of an embodiment of the present invention;

FIG. 3 shows a perspective view of an embodiment of the tool bit of the present invention;

FIG. 4 shows a side elevation view of an embodiment of the tool bit of the present invention;

FIG. 5 shows a side elevation view with a cross-sectional view of a portion of an embodiment of the present invention;

FIG. 6 shows a perspective view of a portion of an embodiment of the present invention;

FIG. 7A shows a perspective view of a portion of another embodiment of the present invention;

FIG. 7B shows a cross-sectional view of a portion of another embodiment of the present invention;

FIG. 7C shows a perspective view of a portion of another embodiment of the present invention;

FIG. 8A shows a side elevation view of a portion of another embodiment of the present invention;

FIG. 8B shows a cross-sectional view of a portion of another embodiment of the present invention; and,

FIG. 8C shows a perspective view of a portion of another embodiment of the present invention.

It will be understood by those skilled in the art that one or more aspects of this invention can meet certain objectives, while one or more other aspects can meet certain other objectives. Each objective may not apply equally, in all its respects, to every aspect of this invention. As such, the preceding objects can be viewed in the alternative with respect to any one aspect of this invention. These and other objects and features of the invention will become more fully apparent when the following detailed description is read in conjunction with the accompanying figures and examples. However, it is to be understood that both the foregoing summary of the invention and the following detailed description are of a preferred embodiment and not restrictive of the invention or other alternate embodiments of the invention. In particular, while the invention is described herein with reference to a number of specific embodiments, it will be appreciated that the description is illustrative of the invention and is not constructed as limiting of the invention. Various modifications and applications may occur to those who are skilled in the art, without departing from the spirit and the scope of the invention, as described by the appended claims For example, even though the discussion of the invention is discussed in relation to dentistry and/or oral surgery applications, its application exceeds and is thus not limited to such medical and/or dental applications and is applicable to any hand operated tool or instrument. Likewise, other objects, features, benefits and advantages of the present invention will be apparent from this summary and certain embodiments described below, and will be readily apparent to those skilled in the art. Such objects, features, benefits and advantages will be apparent from the above in conjunction with the accompanying examples, data, figures and all reasonable inferences to be drawn therefrom, alone or with consideration of the references incorporated herein.

### DETAILED DESCRIPTION OF A PREFERRED EMBODIMENT

With reference to the drawings, the invention will now be described in more detail. Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are herein described.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more”, “at least”, “but not limited to” or other like phrases in some instances shall not be read to mean that the narrower case is intended or required in instances where such broadening phrases may be absent.

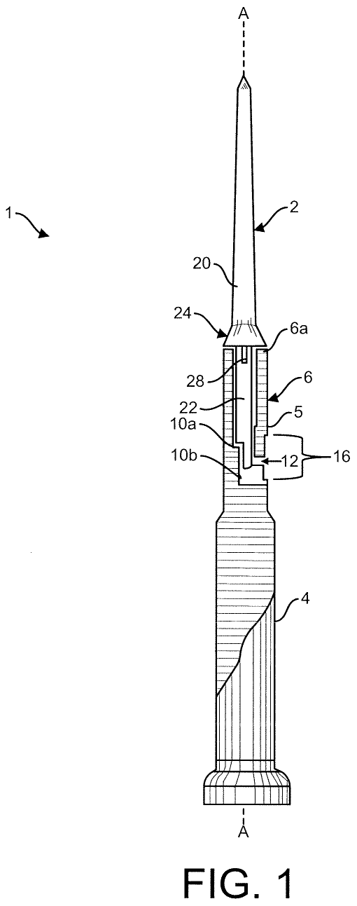

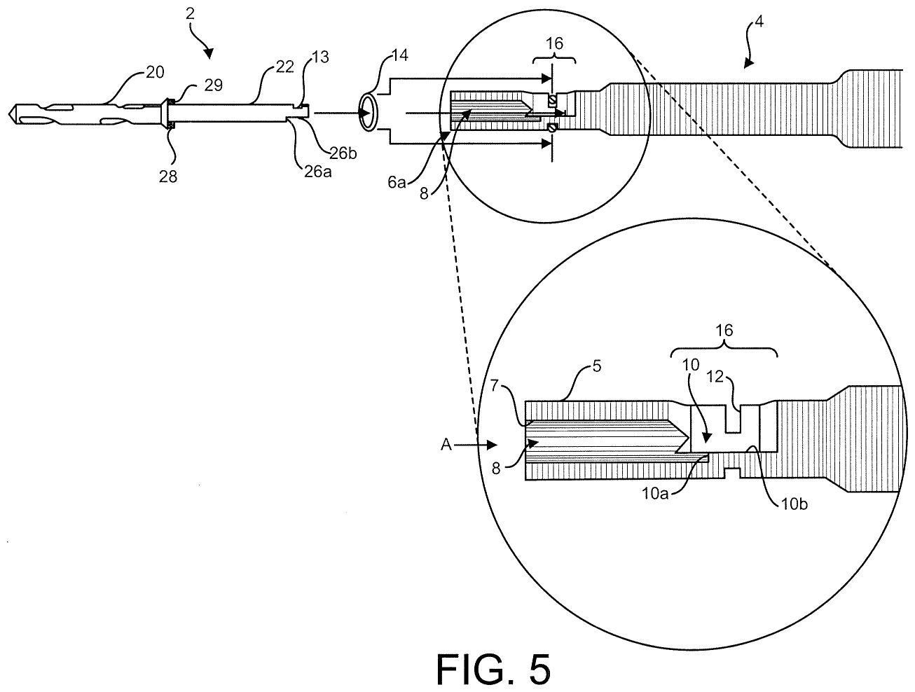

Referring now to FIGS. 1-6, the present invention is shown generally as 1 and relates to a hand operated dental instrument capable of receiving and securing various tool bits (both rotary and non-rotary in nature), such as osteotomes, periotomes, drill bits, flat head bits, Phillips head bits, cutting bits, planing or shaping bits (such as chisel bits) as well as any other tool bits that are generally known, whether such bits are rotary or non-rotary in nature. As can be seen in FIGS. 1 and 5, once secured to the shaft 6, the tool bit, which is generally shown as 2, can be used by maneuvering the instrument 1 in the manner necessary to achieve the desired result with the tool bit.

The dental instrument 1 includes a handle 4 that may be gripped by the user and used to manipulate or move the dental instrument. Generally speaking, the handle 4 can be rotated, spun, reciprocated or moved in an manner desired to cause the tool bit 2 to move in the desired manner. The dental instrument further includes a shaft 6 that has a proximal end 6b that is carried by the handle 4 and a distal end 6a that is adapted for receiving and securing the tool bits 2. The shaft's proximal end 6b may be integral with the handle 4 or may be removably attached thereto. In the present embodiment, the shaft is cylindrically shaped and, thus, has a radiused outer surface 5. In alternate embodiments, however, the shaft's outer surface 5 could have any number of cross-sectional shapes that are generally known such as square, rectangular, hexagonal, octagonal and/or triangular. In such cases, the shaft would have a number of sides that form the outer surface of the shaft.

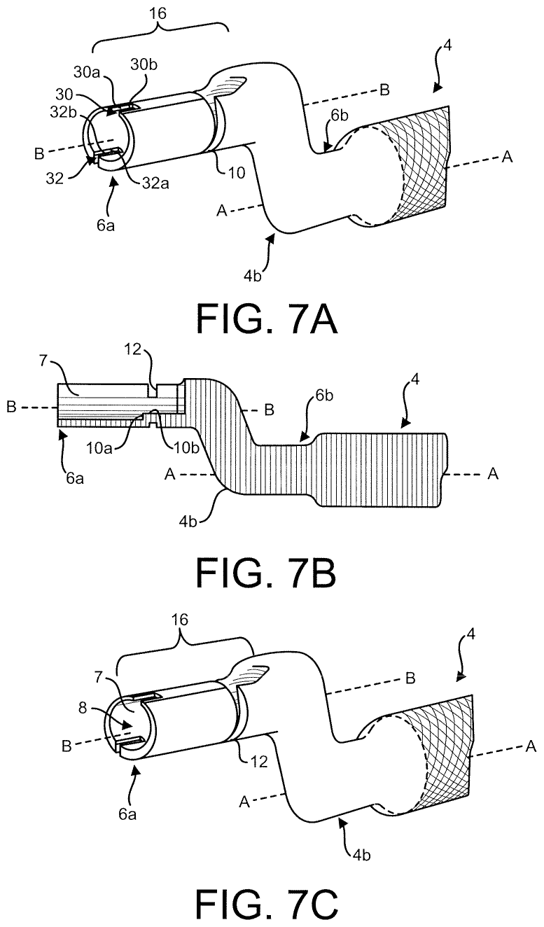

In the shown embodiment, the shaft 6 is carried by the handle 4 so that the shaft extends along the longitudinal axis (A) of the handle 4 such that longitudinal axis (A) of the shaft 6 is the same as the longitudinal axis for the handle. As discussed more fully in FIGS. 7A-C and 8A-C, in alternate embodiments, however, the shaft 6 may be offset from the longitudinal axis (A) of the handle 4. In even further embodiments, the shaft 6 could extend at an angle from the handle 4 so that the shaft 6 is in an angled relation with the handle. This angled relationship could provide the user with additional torqueing force for rotating the shaft 6.

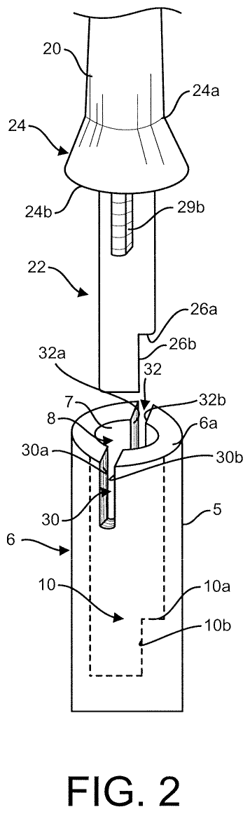

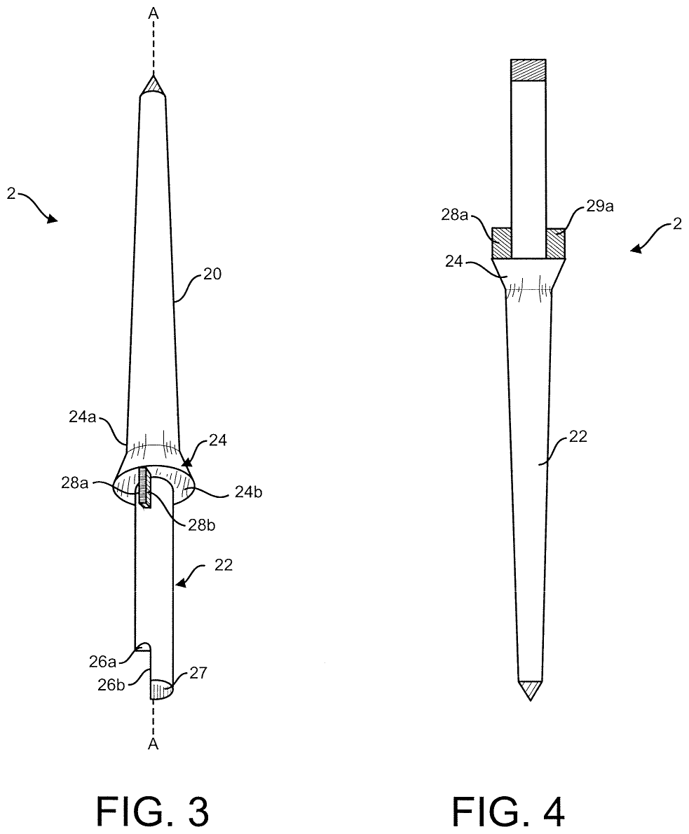

As seen in FIGS. 2-3, a bore-hole 8 is formed in at least a portion of the shaft 6 and extends from the distal end 6a of the shaft to a point that is closer to the proximal end 6b of the shaft. This bore-hole 8 creates a channel into which tool bits 2 can be inserted. In one embodiment, the channel created by the bore-hole 8 is completely enclosed creating a tunnel through a portion of the shaft 6. In alternate embodiments, however, the bore-hole 8 could define a channel that is not completely enclosed but is instead generally “U” or horseshoe shaped. In one embodiment, the bore-hole 8 extends generally along the longitudinal axis (A) of the shaft so that the handle's longitudinal axis (A) extends generally through the center of the bore-hole 8. In alternate embodiments, the bore-hole 8 could be offset from the shaft's longitudinal axis (A) so that the handle's longitudinal axis (A) does not extend through the center of the bore-hole. In the shown embodiment, the bore-hole 8 has a cross sectional shape that is circular. In such an embodiment, the bore-hole is defined by a single curved inner side wall 7. In alternate embodiments, the bore-hole 8 could be defined by a plurality of inner side walls giving the bore-hole a cross sectional shape that could be any number of shapes generally known such as “U” or horseshoe shaped, square, rectangular, hexagonal, octagonal and/or triangular. In embodiments where the bore-hole is not fully enclosed, the at least one inner side wall 7 would not connect to itself, or in the case of multiple inner side walls, at least two of the inner side walls would not connect to one another.

The dental instrument may further include an elevated stop 10 disposed in the bore-hole 8 that is adapted to engage at least a portion of the tool bit shank 22 once it has been inserted into the bore-hole 8. Generally speaking, the elevated stop 10 engages and secures the tool bit shank 22 (at the shank's corresponding shank stop walls 26a-b) to ensure that the manipulation of the handle 4 or shaft 6 will cause the desired movement and/or use of the tool bit 2. The elevated stop 10 comprises a first stop wall 10a that extends inwardly from the inner side wall 7 forming bore-hole 8 and generally towards the center of the bore-hole. In the embodiments where the bore-hole 8 is formed by multiple inner side walls, the first stop wall 10a could extend inwardly from two or more of the inner side walls 7. In the shown embodiment, the first stop wall 10a of the elevated stop 10, extends in a direction that is generally perpendicular to the longitudinal axis (A) of the shaft 6. In alternate embodiments, however, the first stop wall 10a could extend in an angular relation to the shaft's longitudinal axis (A), where that angle is either greater than or less than 90 degrees. In the shown embodiment, the first stop wall 10a engages the tool bit shank 22 at its first shank stop wall 26a to ensure that the tool bit shank 22 may only be inserted to a desired depth within the bore-hole, thus, ensuring that at least a portion of the tool bit 2 protrudes from the bore-hole 8.

The elevated stop 10 further includes a second stop wall 10b that extends from the first stop wall 10a in a direction that is preferably generally parallel to the shaft's longitudinal axis (A). The second stop wall 10b has a generally flat surface that engages the tool bit shank 22 at its second shank stop wall 26b that creates a generally flat surface so that when the handle 4 or shaft 6 of the present invention is rotated, the tool bit 2 will also rotate. In alternate embodiments, the second stop wall 10b could extend in an angled relation to the shaft's longitudinal axis (A) (said longitudinal axis of the shaft being shown as (B) on FIGS. 7A-C and 8A-C).

One embodiment, the present invention further includes a securing ring receiving slot 12 that is defined in the outer surface 5 of the shaft 6 and is adapted to receive a securing ring 14. This securing ring receiving slot 12 is disposed in the shaft 6 such that at least a portion of the slot 12 extends through one or more of the inner side walls 7 that define the bore-hole 8. Thus, at least a portion of the securing ring receiving slot 12 is placed in fluid communication with the bore-hole 8. The securing ring receiving slot 12 may extend around the shaft's entire outer surface 5 so that the slot 12 extends around the entire circumference or perimeter of the shaft 6. Alternatively, the securing ring receiving slot 12 only extends around a portion of the shaft's outer surface 5. In at least one embodiment, the securing ring receiving slot 12 extends through one or more of the inner side walls 7 at a point that is directly above or opposite from the second stop wall 10b located in the bore-hole and the flat surface created thereby.

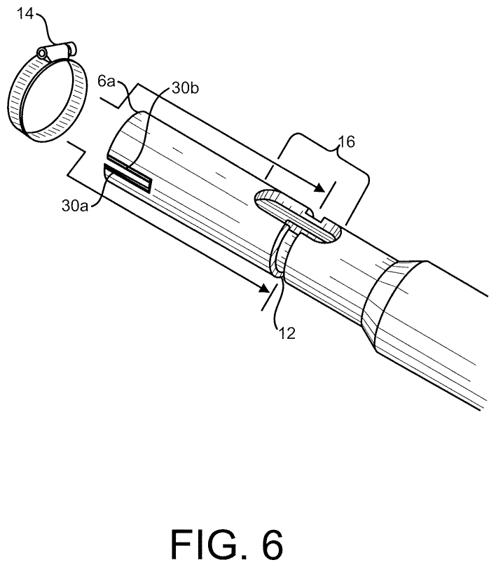

When placed in the securing ring receiving slot 12, the securing ring 14 extends into at least a portion of the bore-hole and engages at least a portion of the tool bit shank 22 (which may have a shank slot 13 that corresponds to the securing ring receiving slot 12). The securing ring 14 may be made of an elastic or flexible material or can otherwise be adjustable so that the diameter of the securing ring can be adjusted to be greater or smaller. As shown in FIG. 5, the securing ring 14 could comprise an O-ring made of any elastic material known in the art. Alternatively, and as shown in FIG. 6, the securing ring 14 could comprise a pipe ring or any other mechanism, such as a clamp, that allows the diameter of the securing ring to be adjusted. The securing ring 14 presses the tool bit shank 22 towards the elevated stop 10 to ensure that rotation of the handle 4 or shaft 6 of the present invention will cause the tool bit 2 to rotate. Preferably, the securing ring 14 maintains contact between at least a portion of the tool bit shank 22 and the second stop wall 8b. However, the securing ring 14 is meant to press the tool bit shank 22 towards at least one of the first and second stop walls 8a and 8b. Regardless of whether contact is made with both stop walls, the force applied by the securing ring 14 is sufficient to allow the elevated stop 10 to engage a portion of the tool bit shank to ensure rotation of the tool bit 2 when the handle 4 or shaft 6 of the present invention is rotated.

The present invention may further include an access opening 16 that is defined in the shaft 6 so that the access opening 16 extends through the inner side wall 7 of the bore-hole 8, thus placing the access opening 16 in fluid communication with the bore-hole 8. This access opening 16 allows the user to access the securing ring 14 to remove the securing ring from the securing ring receiving slot 12. In one embodiment, the access opening 16 extends through securing ring slot 12 as shown in FIGS. 1-6. In alternate embodiments, however, the access opening 16 could be disposed adjacent to the securing ring receiving slot 12. In some embodiments, access opening 16 is in fluid communication with securing ring receiving slot 12 but not with bore-hole 8.

In one embodiment, the invention includes a tool bit 2 having a body 20 that forms any number of tools known in the art, including but not limited to osteotomes, periotomes, drill bits, flat head bits, Phillips head bits, cutting bits, planing or shaping bits (such as chisel bits). The tool bit may further include a shank 22 that is adapted to be received by the bore-hole 8 and a flange 24 interconnecting the tool bit body 20 and the shank 22. In one embodiment, the shank 22 includes a first shank stop wall 26a that is generally perpendicular to the longitudinal axis (A) of the shank as well as a second shank stop wall 26b that is generally perpendicular to the longitudinal axis (A) of the shank. When the shank is inserted into the bore-hole 8 the first and second shank stop walls 26a-b will engage the first and second elevated stops 10a-b located in the bore-hole 8.

In one embodiment, the flange 24 interconnects the body 20 to the shank 22 such that the flange has a first end 24a that is carried by the body and in the shown embodiment is integral with the body, as well as a second end 24b that is connected to the shank 22. In one embodiment, the second end 24b defines a flat surface that may lie flush against the distal end 6a of the shaft 6 when the shank 22 is inserted in the bore-hole 8. The flange 24 provides additional support and strength to the body 20 by absorbing some of the forces applied to the body 20 and/or transferring some of those forces to the shaft 6. In the shown embodiment, the flange's second end 24b, has a cross-sectional shape that is circular and has a diameter that is generally equal to the diameter of the shaft 6 when measured from the shaft's outer surface 5. In the shown embodiment, the flange 24 is tapered such that the diameter of the first end 24a is smaller than the diameter of the flange's second end 24b.

As shown in FIG. 5, in at least one embodiment, the shank 22 includes a shank slot 13 that corresponds to the securing ring receiving slot 12 defined in the shaft 6. This shank slot 13 is adapted to receive the securing ring 14 and help keep the securing ring in place.

Referring to FIGS. 3-4, the present invention further includes splines 28-29. The splines 28-29 are adapted to be received by the spline receiving slots 30 & 32 that are defined in the distal end 6a of the shaft 6. In the shown embodiment, there are two splines that have a generally rectangular shape but there could be any number of splines having any shape. In the shown embodiment, splines 28-29 extend outwardly from the flange's second end 24b and extend along (and parallel to) the longitudinal axis (A) of the shank 22 such that the spline is in contact with both the flange's second end 24b and the shank 22. In an alternate embodiment, one or both of the splines 28-29 could be carried solely by the shank 22 so that the spline is laterally spaced from the flange's second end 24b. In another embodiment, one or both of the splines 28 & 29 could be carried solely by the flange's second end 24b so that that the spline is laterally spaced from the shank 22.

Referring to FIG. 2, the shaft's distal end 6b includes spline receiving slots 30 & 32. In the shown embodiment, the spline receiving slots extend through the shafts outer surface 5 and through the shaft's inner side wall 7 so that the spline receiving slots are in fluid communication with the bore-hole 8. In alternate embodiments, however, the spline receiving slots extend through the shaft's outer surface 5 but not the inner side wall 7 or through the shaft's inner side wall 7 but not the shaft's outer surface 5 or in some cases, neither of the outer surface nor the inner sidewall. The spline receiving slots include a first side wall 30a and 32a and a second side wall 30b and 32b that are adapted to engage one or both of the splines 28-29 so that when the handle 4 or shaft 6 is rotated, one or both of the spline receiving slot's side walls contact the spline and cause the tool bit 2 to rotate.

In at least one embodiment, one or more of the splines 28-29 as well as the corresponding spline receiving slots 30 and 32 are tapered. In this embodiment, the distance between the spline's first and second side walls 28a-b & 29a-b increases as the flange 24 is approached and decreases as the distal end 27 of the shank 22 is approached. In this embodiment, the distance between spline receiving slot's side walls 30a-b and 32a-b increases as the shaft's distal end 6a is approached and decreases as the shaft's proximal end 6b is approached. This tapering provides additional stability to the tool bit 2 and helps ensure that the shank 22 remains in the bore-hole 8 by providing a friction fit between the tapered splines and the tapered spline receiving slots.

Referring now to FIGS. 7A-7C, another embodiment of the invention is shown. In this embodiment, the shaft 6 is offset from the handle 4 such that the shaft's longitudinal axis (B) is parallel to but spaced from the longitudinal axis (A) of the handle 4. By offsetting the shaft from the handle, the user is able to more easily use the tool to reach the molars and other teeth located in the rear of the patient's jaw. As can be seen in these figures, the shaft may be offset from the handle by means of using a curved or bent portion of the shaft 4b. In other embodiments (not shown) the tool could include a connector piece that would vertically space the shaft from the handle in the desired manner.

As can also be seen in these figures, the access opening 16 may extend from the shaft's distal end 6a to a desired point closer to the proximal end 6b of the shaft and/or adjacent to the securing ring receiving slot 12. In this embodiment, the bore-hole 8 would not be fully enclosed such that the inner side wall 7 forming the bore-hole 8 would not connect, creating a substantially “U” shaped horse-shoe shaped bore-hole 8.

In embodiments where the bore-hole is not fully enclosed, the access opening 16 may extend to the tip of the distal end 6a of the shaft 6 and along the entire length of the bore-hole 8 or a substantial portion thereof. As shown in FIG. 7A, the spline receiving slots 30 and 32 can be defined in the shaft 6 at a point that is spaced from the access opening 16. In alternate embodiments, the access opening 16 may serve as one or more of the spline receiving slots as shown in FIG. 7C.

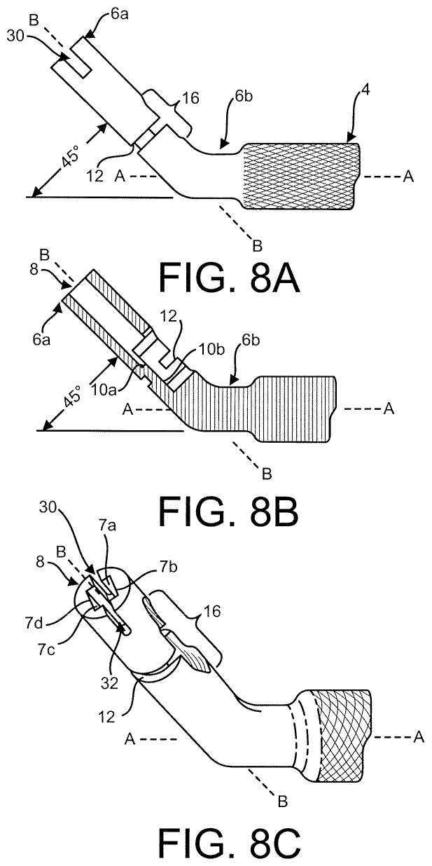

In embodiments, such as the one shown in FIGS. 8C, where the bore-hole 8 is defined by multiple inner side walls 7a-7d, the access opening 16 may extend from the distal end 6a in a manner where at least a portion of two of the inner side walls do not connect to one another.

Referring now to FIGS. 8A-C, another embodiment of the invention may be seen. In this embodiment, the shaft 6 extends from the handle 4 in an angled manner so that the shaft's longitudinal axis (B) intersects the handle's longitudinal axis (A) at an angle. In at least one embodiment, the angle between the shaft 6 and the handle 4 is approximately 45 degrees. In alternate embodiments, the angle between the shaft and the handle could be greater than or equal to 0 degrees but less than or equal to 90 degrees, or greater than or equal to 90 degrees but less than or equal to 180 degrees.

As can be seen in these figures, the bore-hole 8 can be defined by a plurality of inner side walls 7a-7d. In such embodiments, the need for the elevated stop 10 may be alleviated as the two or more of the inner side walls 7a-7d would engage a tool bit shank 22 having an equal number of corresponding sides (not shown) so that when the shaft 6 or handle 4 is rotated, the tool bit 2 rotates. In such an embodiment, however, it may still be desirable to include one or more spline receiving slots 30 and 32 that are tapered and are adapted to receive tapered splines so that when the tool bit shank 22 is inserted into the bore-hole 8 the friction between the splines 28-29 and the spline receiving slot's side walls 30a-b helps keep the tool bit in place.

In operation, a tool bit 2 is inserted into the bore-hole 8 so that at least a portion of the tool bit shank 22 is engaged by the elevated stop 10. Ordinarily, the first stop wall 8a will contact and engage a corresponding first shank stop wall 26a and the second stop wall 8b will contact and engage a corresponding second shank stop wall 26b. Once the tool bit 2 has been inserted into the bore-hole 8, the securing ring 14 can be placed in the securing ring receiving slot 12. Once in place, the securing ring presses at least a portion of the tool bit shank towards the elevated stop. In cases where the tool bit includes a shank slot 13, the securing ring 14 will engage the shank slot 13 of the tool bit. In a preferred embodiment, the securing ring 14 will cause the second stop wall 8b to contact or otherwise engage the second shank stop wall 26b so that when the handle 4 or the shaft 6 of the present invention is rotated, spun or subjected to a torqueing force, the tool bit 2 is caused to rotate. The securing ring 14 also preferably provides enough pressure on at least a portion of the tool bit shank 22 that it reduces or prevents the tool bit shank 22 from sliding out of the bore-hole 8. This preferred objective is more easily accomplished when the tool bit shank 22 includes a shank slot 13.

In alternate embodiments, there the securing ring 14, securing ring receiving slot 12, elevated stop 10 and shank stop walls 26a-b may be omitted. In such an embodiment, the splines 28-29 and the spline receiving slots 30 & 32 are sufficient to both secure the tool bit 2 to the shaft 6 and to ensure rotation of the tool bit 2 in response to rotation of the handle 4 and/or shaft 6. Thus, manipulation of the handle 4 or shaft 6 of the present invention will allow the tool bit to be operated in a desired manner. Because the tool is hand operated, the user will have better control over the speed of and pressure under which the tool bit is operated. Further, the hand operated nature of the present invention will also minimize the effect of accidental placement of the tool bit so that misplacement of the tool bit 2 will result in less damage to the area being subjected to the tool bit.

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art using the teachings disclosed herein.

What is claimed is:

1. A hand operated instrument comprising:
a handle;
a shaft having an outer surface, a distal end and a proximal end wherein said proximal end is carried by said handle;
a bore-hole defined in at least a portion of said shaft and extending from said distal end of said shaft towards said proximal end of said shaft, wherein said bore-hole is defined by at least one inner side wall;
a spline receiving slot defined in said outer surface of said shaft and including a first side wall and a second side wall, both of which extend from said distal end of said shaft towards said handle, so that said spline receiving slot extends in a direction that is generally parallel to a longitudinal axis of said shaft;
a tool bit having a body, a shank and a flange interconnecting said body and said shank, wherein said tool bit further includes a spline extending from a point that is adjacent to said flange and in a direction that is parallel to a longitudinal axis of said shank, said spline being adapted to be received by said spline receiving slot so that when said shank is inserted into said bore-hole and said handle is rotated, said spline engages at least one of said first side wall and said second side wall of said spline receiving slot so that rotation of said handle causes said tool bit to rotate.

2. The hand operated instrument of claim 1 further comprising an elevated stop defined in said bore-hole for engaging a portion of said shank of said tool bit that is inserted into said bore-hole, wherein said elevated stop comprises:
a first stop wall that extends from said at least one inner side wall of said bore-hole in a direction that is generally perpendicular to the longitudinal axis of said shaft; and,
a second stop wall the extends from said first stop wall in a direction that is generally parallel to the longitudinal axis of said shaft.

3. The hand operated instrument of claim 2 wherein said tool bit further includes a first shank stop wall defined in said shank and extending in a direction that is generally perpendicular to the longitudinal axis of said shank and a second shank wall extending from said first shank stop wall in a direction that is generally parallel to the longitudinal axis of said shank, wherein when said shank is inserted into said bore-hole, said second shank wall engages said second stop wall so that rotation of said handle causes the shank to rotate.

4. The hand operated instrument of claim 1 further comprising a securing ring receiving slot defined in said shaft, wherein at least a portion of said securing ring receiving slot extends through said at least one inner side wall of said bore-hole so that said securing ring receiving slot is in fluid communication with said bore-hole.

5. The hand operated instrument of claim 4 further comprising a securing ring, at least a portion of which is received by said securing ring receiving slot so that at least a portion of said securing ring extends into said bore-hole so that said securing ring engages a portion of said shank that has been inserted into said bore-hole so that said securing ring presses said second shank wall towards at least one of said first stop wall and said second stop wall of said elevated stop.

6. The hand operated instrument of claim 1 wherein said spline receiving slot is in fluid communication with bore-hole such that at least one of said first side wall and said second side wall extends through both of said outer wall of said shaft and said inner wall of said bore-hole.

7. The hand operated instrument of claim 1 wherein said flange of said tool bit has a first end carried by said body of said tool bit and a second end that carries said shank, wherein said flange is tapered so that said second end has a diameter that is greater than a diameter of said first end and wherein said second end includes a generally flat surface. The hand operated instrument of claim 1 wherein said spline contacts at least a portion of said shank.

9. The hand operated instrument of claim 1 wherein
said spline receiving slot is tapered such that said spline receiving slot includes an opening defined in said distal end of said shaft, a proximal end opposite of said opening, wherein said distal end has a first distance between said first side wall and said second side wall that is greater than a second distance between said first side wall and said second side wall at said proximal end; and
said spline is tapered so that when said shank is inserted into said bore-hole, at least a portion of a first side of said spline contacts said first side wall of said spline receiving slot and at least a portion of a second side of said spline contacts said second side wall of said spline receiving slot.

10. A hand operated dental instrument comprising:
a handle;
a shaft having an outer surface, a distal end and a proximal end wherein said proximal end is carried by said handle;
a bore-hole defined in at least a portion of said shaft and extending from said distal end of said shaft towards said proximal end of said shaft, wherein said bore-hole is defined by at least one inner side wall and is adapted to receive a first portion of a tool bit;
an elevated stop defined in said bore-hole for engaging the first portion of the tool bit, wherein said elevated stop comprises:
a first stop wall that extends from said at least one inner side wall of said bore-hole in a direction that is generally perpendicular to the longitudinal axis of said shaft; and,
a second stop wall the extends from said first stop wall in a direction that is generally parallel to the longitudinal axis of said shaft;
a securing ring receiving slot defined in said shaft, wherein at least a portion of said securing ring receiving slot extends through said at least one inner side wall of said bore-hole so that said securing ring receiving slot is in fluid communication with said bore-hole; and,
whereby when the first portion of the tool bit is inserted into said bore-hole said elevated stop engages the first portion of the tool bit so that rotation of said handle causes the tool bit to rotate.

11. The hand operated instrument of claim 10 further comprising a spline receiving slot adapted to receive a second portion of a tool bit, wherein said receiving slot is defined in said shaft and includes a first side wall and a second side wall, both of which extend from said distal end of said shaft towards said handle, so that said spline receiving slot extends in a direction that is generally parallel to a longitudinal axis of said shaft so that when the first portion of the tool bit is inserted into said bore-hole, said spline receiving slot receives the second portion of the tool bit.

12. The hand operated instrument of claim 11 wherein said spline receiving slot is in fluid communication with bore-hole such that at least one of said first side wall and said second side wall extends through both of said outer wall of said shaft and said inner wall of said bore-hole.

13. The hand operated instrument of claim 11 wherein said spline receiving slot is tapered such that said spline receiving slot includes an opening defined in said distal end of said shaft, a proximal end that is opposite of said opening, wherein said opening has a first distance between said first side wall and said second side wall that is greater than a second distance between said first side wall and said second side wall at said proximal end.

14. The hand operated instrument of claim 10 further comprising a securing ring, a portion of which is received by said securing ring receiving slot so that at least a portion of said securing ring extends into said bore-hole so that at least a portion of said securing ring contacts the first portion of the tool bit that has been inserted into said bore-hole so that said securing ring presses at least a portion of the tool bit towards at least one of said first stop wall and said second stop wall of said elevated stop.

15. A hand operated instrument comprising:
a tool bit comprising:
a body, a shank and a flange interconnecting said body and said shank,
wherein;
a spline extending along at least a portion of a longitudinal axis of said shank;
a first shank stop wall defined in said shank and extending in a direction that is generally perpendicular to the longitudinal axis of said shank;
a second shank wall extending from said first shank stop wall to a distal end of said shank in a direction that is generally parallel to the longitudinal axis of said shank;
a handle having a distal end and a proximal end;
a bore-hole defined in at least a portion of said handle and extending from said distal end of said handle towards said proximal end of said handle, wherein said bore-hole is defined by at least one inner side wall;
whereby when at least a portion of said shank is inserted into said bore-hole, at least one of said spline and said second shank wall engages said inner side wall of said bore-hole so that rotation of said handle causes said tool bit to rotate.

16. The hand operated dental instrument of claim 15 wherein said body of said tool bit comprises one of an osteotomes, periotomes, drill bits, flat head bits, Phillips head bits, cutting bits, planing and shaping bits.

17. The hand operated instrument of claim 15 wherein said flange of said tool bit has a first end that is adjacent to said body and a second end that adjacent to said shank, wherein said flange is tapered so that said second end has a diameter that is greater than a diameter of said first end and wherein said second end includes a generally flat surface that when viewed along the longitudinal axis of said shank has a cross-sectional shape that is circular and has a diameter that is equal to a diameter of said handle.

18. The hand operated instrument of claim 15 wherein said spline includes:
a proximal end that is adjacent to said flange;
a distal end that is adjacent to said distal end of said shank;
a first side wall and a second side wall, both of which extend between said proximal end and said distal end of said spline, wherein said spline is tapered so that a first distance between said first side wall and said second side wall at said proximal end of said spline is greater than a second distance between said first side wall and said second side wall at said distal end of said spline.

19. The hand operated instrument of claim 18 further including a tapered spline receiving slot defined in said handle and including a first side wall and a second side wall, both of which extend from said distal end of said handle towards said proximal end of said handle such that said spline receiving slot includes an opening defined in said distal end of said shaft, a proximal end opposite of said opening, wherein said opening of said spline receiving slot has a first distance between said first side wall and said second side wall that is greater than a second distance between said first side wall and said second side wall at said proximal end of said spline receiving slot.

20. The hand operated instrument of claim 15 further comprising a spline receiving slot defined in said handle and including a first side wall and a second side wall, both of which extend from said distal end of said handle towards said proximal end of said handle, said spline receiving slot being adapted to received said spline so that when at least a portion of said shank is inserted into said bore-hole and said handle is rotated, said spline engages at least one of said first side wall and said second side wall of said spline receiving slot so that rotation of said handle causes said tool bit to rotate.
